(19) United States
(12) Patent Application Publication
(10) Pub. No.: US 2007/0243367 A1
(43) Pub. Date: Oct. 18, 2007

(54) Method of manufactueing an optical functional film,optcal functionalfilm, polarizing plate,optical element and image display device

(75) Inventors: Wataru Nagatake, Osaka (JP); Seiji Kondou, Osaka (JP); Keiichi Okamoto, Osaka (JP); Ryouichi Takamura, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Ibaraki-shi (JP)

(21) Appl. No.: 11/661,831

(22) PCT Filed: Jul. 3, 2006
(86) PCT No.: PCT/JP06/13213

§ 371 Date: Mar. 5, 2007

(30) Foreign Application Priority Data
Jul. 4, 2005 (JP) 2005-195391

(51) Int. Cl. A01K 1/015; B29D 7/01

(52) U.S. Cl. 428/221; 264/1.34

(57) ABSTRACT

A method of manufacturing an optical functional film including an application step of applying a resin solution onto a substrate film made of a thermoplastic resin and an immobilizing step of immobilizing a resin applied to form a resin layer, characterized by that it further comprises, prior to the application step, a stretching step of stretching the substrate film with the substrate film kept heated.

### FIELD OF THE INVENTION

The present invention relates to a method of manufacturing an optical functional film and an optical functional film, as well as a polarizing plate and an optical element each having the optical functional film, and an image display device.

### BACKGROUND OF THE INVENTION

In recent years, there is a tendency that many liquid crystal display devices of low-profile, light-weight, and low power consumption are used as display devices of office automation equipments, such as TV sets and personal computers. The liquid crystal display device of this type is made up of a laminate of various optical functional layers, such as an optical compensation layer, a hard coat layer, an antireflection layer and a retardation layer, as well as a liquid crystal layer and a polarizing plate. Accordingly, these optical functional layers are required to not only exhibit the performances to be met to the purposes of the respective layers, but also cause no adverse influences on a displayed image of an image display device as a prerequisite for it.

### SUMMARY OF THE INVENTION

### Means to Solve the Problems

However, an optical functional film as manufactured for use as these optical functional layers may have appearance defect therein, such as very fine streak-form unevenness and dot unevenness.

In consideration of the above problem associated with the prior art, it is an object of the present invention to provide a method of manufacturing an optical functional film that is unlikely to have appearance defect.

It is another object of the present invention to provide an image display device that has excellent image display characteristics.

### Means to Solve the Problems

In general, there are many cases in which optical functional films are manufactured by an application step of applying a resin solution onto a substrate film, and an immobilizing step of immobilizing a resin coated to form a resin layer. The present inventors made intensive investigations and found that the probability of the aforesaid appearance defect can be reduced by heat stretching a substrate film prior to application of a resin solution onto the substrate film, and thus achieved the present invention.

According to the present invention, there is provided a method of manufacturing an optical functional film including an application step of applying a resin solution onto a substrate film made of a thermoplastic resin and an immobilizing step of immobilizing a resin applied to form a resin layer, characterized by that it further comprises, prior to the application step, a stretching step of stretching the substrate film with the substrate film kept heated.

By a stretching ratio in the present invention is meant a ratio of the length in the stretching direction after stretching relative to the length in the stretching direction before stretching, of a substrate film to be stretched.

An optical functional film of the present invention is manufactured by the aforesaid optical functional film manufacturing method; a polarizing plate of the present invention is made up of a laminate of the optical functional film and a polarizer; and an optical element and an image display device, of the present invention, are each formed by laminating the optical functional film thereon.

### ADVANTAGES OF THE INVENTION

According to the optical functional film manufacturing method of the present invention, a step of heat stretching a substrate film is carried out prior to application of a resin solution, so that a minute roughness surface of the substrate film is smoothed and hence a resin layer laminated thereon can be smoothed. As a result, it is possible to manufacture an optical functional film with much less appearance defect. An image display device of the present invention uses the optical functional film having much less appearance defect so that it has remarkably excellent image display characteristics.

### BRIEF DESCRIPTION OF THE DRAWINGS

FIG. 1 illustrates diagrams showing the comparison of actual measurement values of the surface roughness and the declination angles provided in Example 1 and Comparative Example 1.

FIG. 2 illustrates diagrams showing the comparison of actual measurement values of the surface roughness and the declination angles provided in Example 6, Comparative Example 4 and Comparative Example 5.

FIG. 3 illustrates diagrams showing the comparison of actual measurement values of the surface roughness and the declination angles provided in Example 7 and Comparative Example 6.

### DETAILED DESCRIPTION OF THE PREFERRED EMBODIMENT

Now, the description will be made for a method of manufacturing an optical functional film of the present invention.

According to the present invention, a method of manufacturing an optical functional film, which includes an application step of applying a resin solution onto a substrate film made of a thermoplastic resin and an immobilizing step of immobilizing a resin applied to form a resin layer, is characterized by that the method further includes, prior to the application step, a stretching step of stretching the substrate film with the substrate film kept heated.

As an example of the substrate film, it can be cited a film made of a transparent polymer, such as polyester polymers, such as polyethylene terephthalate and polyethylene naphthalate; cellulose polymers, such as cellulose cliacetate and cellulose triacetate; polycarbonate polymers; and acrylic polymers, such as polymethyl methacrylate.

It is also possible to cite a film made of a transparent polymer, such as styrene polymers, such as polystyrene and acrylonitrile-styrene copolymer; olefin polymers, such as polyethylene, polypropylene, polyolefin having a cyclo or norbornene structure and ethylene-propylene copolymer; vinyl chloride polymers; and amide polymers, such as Nylon and aromatic polyamide.

It can be also cited a film made of a transparent polymer, such as imide polymers; sulfone polymers; polyether-sulfone polymers, polyether-ether-ketone polymers; polyphenylene sulfide polymers; vinyl alcohol polymers; vinylidene chloride polymers; vinyl butyral polymers; allylate polymers; polyoxymethylene polymers; epoxy polymers; and blends of these polymers. Especially in optical property, a film having small birefringence is suitably used.

As the substrate film, cellulose polymers, such as cellulose triacetate is preferable and a cellulose triacetate film is especially preferable from the view point of the light polarizing property and endurance.

As a substrate film, it can also be cited polymer films disclosed in Japanese Patent Application Laid-open No. 2001-343529 (WO 01/37007), which contains such as compositions of thermoplastic resins having substituted and/or non-substituted imido group in side chain and thermoplastic resins having substituted and/or non-substituted phenyl group and nitryl group in side chain. As an example, it can be cited a film of a resin composition containing an alternating copolymer of isobutene and N-methylene maleimide and an acrylonitrile-styrene copolymer.

A preferred example of the substrate film is an acrylic resin film containing as a main component an acrylic resin (A) having a glutaric anhydride unit represented by the following structural formula (1) and described in Japanese Patent Application Laid-open No. 2005-314534. The acrylic resin (A) having a glutaric anhydride unit represented by the following structural formula (1) may have improved heat resistance. In the following structural formula (1), R¹ and R² may be the same or different, and each represent a hydrogen atom or a C₁₋₅ (carbon numbers of 1-5) alkyl group, more preferably a hydrogen atom or a methyl group, and furthermore preferably a methyl group.

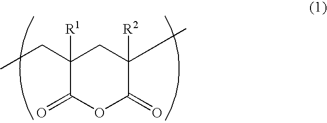

In the acrylic resin (A), a ratio of the glutaric anhydride unit represented by the structural formula (1) is preferably from 20 to 40% by weight, and more preferably from 25 to 35% by weight.

The acrylic resin (A) may contain one or two or more types of appropriate monomer units in addition to the glutaric anhydride unit represented by the structural formula (1). A preferred example of the monomer unit is a vinyl carboxylic acid alkyl ester unit. In the acrylic resin (A), a ratio of the vinyl carboxylic acid alkyl ester unit is preferably from 60 to 80% by weight, and more preferably from 65 to 75% by weight.

An example of the vinyl carboxylic acid alkyl ester unit is a unit represented by the following general formula (2). In the following general formula (2), R³ represents a hydrogen atom or a C₁₋₅ aliphatic or alicyclic hydrocarbon, and R⁴ represents a C₁₋₅ aliphatic hydrocarbon.

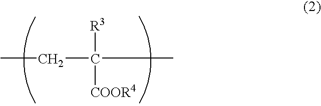

The acrylic resin (A) preferably has a weight-average molecular weight of from 80,000 to 150,000.

A ratio of the acrylic resin (A) in the substrate film is preferably from 60 to 90% by weight.

The substrate film may contain one or two or more types of appropriate components in addition to the aforesaid various resins. Any appropriate component may be employed within a range not inhibiting the purpose of the present invention. Examples of the appropriate component include a resin except the aforesaid resins, a UV absorber, an antioxidant, a lubricant, a plasticizer, a releasing agent, a color protection agent, a flame retardant, a nucleator, an antistatic agent, a pigment, and a colorant.

The thickness of the substrate film can be appropriately determined according to needs and circumstances, and is generally about from 10 to 500 μm, preferably from 20 to 300 μm, and more preferably from 30 to 200 μm from the view point of workability, such as strength and handling property, and thin film characteristics.

The stretching ratio of the substrate film in the stretching step is preferably within a range of from 1.001 to 1.2 times and more preferably within a range of from 1.08 to 1.16 times when the substrate film is a cellulosic polymer, such as triacetylcellulose. It is also preferably within a range of from 1.001 to 4 times and more preferably within a range of from 2 to 3 times when the substrate film is an olefinic polymer having norbornene structure. It is also preferably within a range of from 1.001 to 4 times and more preferably within a range of from 2 to 3 times when the substrate film is an acrylic polymer.

As examples of a method of stretching a substrate film, it can be cited a free-end longitudinal stretching method in which a thermoplastic polymer film is stretched uniaxially in the longitudinal direction; a fixed-end lateral stretching method in which the film is stretched in the lateral direction while the film is fixed in the longitudinal direction; and a tenter stretching method in which the film is stretched in the lateral direction while it is moved in the longitudinal direction.

The tenter stretching is to stretch a substrate film in the lateral direction, for example, by a stretching machine disposed between two rolls, while transferring the substrate film wound around one of the rolls to the other roll. Specifically, the opposite lateral edges of the substrate film are respectively gripped by a pair of gripping members of the stretching machine; the pair of gripping members are moved in the transfer direction of the substrate film while the distance between the pair of gripping members is gradually increased; and the substrate film is released from the gripped state when the ratio of the distance between the gripping members after stretching relative to the distance thereof before stretching has reached a given expansion ratio, thereby stretching the substrate film to a given stretching ratio.

The temperature to which a substrate film is heated in the stretching step is preferably from 80 to 300° C., more preferably from 100 to 200° C. and especially preferably from 120 to 180° C. When the heating temperature is represented based on a glass-transition temperature (Tg) of a resin forming the substrate film, it is preferably from Tg−30° C. to Tg+60° C., more preferably from Tg−10° C. to Tg+40° C., and furthermore preferably Tg+0° C. to Tg+25° C. When the substrate film of the aforesaid thermoplastic resin is heated to these temperatures, it is softened and the softened substrate film is stretched so that a minute roughness surface of the substrate film can be smoothed.

Especially, when the stretching ratio is set within a range of from 1.05 to 1.15, the height difference of the roughness surface is reduced to, for example, not larger than 0.2 μm so that the appearance defect can be significantly reduced.

In the stretching step, the substrate film, which has been once stretched to a maximum stretching ratio, may be relaxed (shrunken) in a direction opposite to the stretching direction. It is possible to suppress the displacement of the orientation axis due to a bowing phenomenon, and further improve the accuracy of each of an in-plane retardation (Δnd) of the substrate film, an out-of-plane retardation (Rth) of the substrate film and the orientation axis by relaxing (shrinking) the substrate film in the stretching step.

The relaxation rate (relaxation rate=the width of the substrate film after relaxing/the width of the substrate film before relaxing) is preferably from 0.85 to 0.999 times, more preferably from 0.98 to 0.998 times and furthermore preferably from 0.990 to 0.995 times.

In a case where a substrate film, which has been once stretched to a maximum stretching ratio, is to be relaxed in the stretching step, the stretching ratio (final stretching ratio) in the present invention is determined as the width of the stretch film after relaxing relative to the width of the stretching film before stretching, that is, (stretching ratio=the width of the substrate film after relaxing/the width of the substrate film before stretching). In other words, the stretching ratio (final stretching ratio) is obtained as a product of a maximum stretching ratio and a relaxation rate.

In a case where a retardation film is manufactured as an optical functional film, it is possible to further stretch the substrate film after a resin layer is formed by the immobilizing step. The stretching ratio may be adjusted to allow the refractive index of the retardation film to be a desirable value according to the intended use of the retardation film.

As an example of the resin material to be applied onto the substrate film, it can be cited a polymer such as polyamide, polyimide, polyester, polyetherketone, polyamide-imide or polyester-imide because of its excellent heat resistance, chemical resistance, transparency and hardness. It may be possible to use one of these polymers alone or a mixture of two or more polymers having different functional groups, for example, a mixture of polyetherketone and polyamide. Among these polymers, polyimide is especially preferable because of its high transparency, high orientation and high stretchability.

The molecular weight of each of the aforesaid polymers is not necessarily limited, but for example the weight-average molecular weight (Mw) is preferably in the range of from 1,000 to 1,000,000 and more preferably in the range of from 2,000 to 500,000.

The polyimide is preferably of the type that has a high in-plane orientation and is soluble in organic solvent. Specifically, a polymer that includes a condensed polymer of 9,9-bis(aminoaryl)fluorene and an aromatic tetracarboxylic acid anhydride, having at least one repeat unit of the following formula (3), as disclosed in Japanese Patent Publication Tokuhyo 2000-511296.

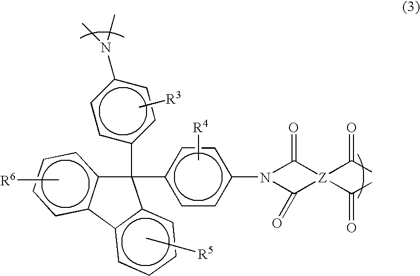

In the above formula (3), R³-R⁶ each are at least one substituent independently selected from the group consisting of hydrogen, halogen, phenyl or phenyl substituted with 1 to 4 halogen atoms or a C₁₋₁₀ (carbon numbers of 1-10) alkyl group, and a C₁₋₁₀ alkyl group, and R³-R⁶ each preferably are at least one substituent independently selected from the group consisting of halogen, phenyl or phenyl substituted with 1 to 4 halogen atoms or a C₁₋₁₀ alkyl group, and a C₁₋₁₀ alkyl group.

In the above formula (3), Z is for example a tetravalent aromatic group having 6 to 20 carbon atoms, and preferably a pyromellitic group, a polycyclic-aromatic group, derivatives of a polycyclic-aromatic group, or a group represented by the following formula (4).

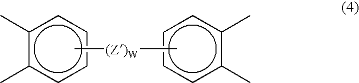

In the above formula (4), Z′ represents for example a covalent bond, a C(R⁷)₂ group, a CO group, an O atom, an S atom, an SO₂ group, an Si(C₂H₅)₂ group, or an NR⁸ group, and when there are plural Z's, they may be the same or different. W represents an integer from 1 to 10. R⁷ each are independently hydrogen or C(R⁹)₃. R⁸ is hydrogen, a C₁₋₂₀ alkyl group, or a C₆₋₂₀ aryl group, and when it is plural, they may be the same or different. R⁹ each are independently hydrogen, fluorine or chlorine.

An example of the polycyclic-aromatic group includes a tetravalent group derived from naphthalene, fluorene, benzofluoren or anthracene. Examples of the derivatives of the polycyclic-aromatic group include the polycyclic-aromatic group substituted with at least one selected from the group consisting of a C₁₋₁₀ alkyl group, its fluorinated derivatives, and halogens such as F and Cl.

Further examples of the polymer include homopolymer having a repeat unit represented by the following formula (5) or (6), or polyimide having a repeat unit represented by the following forumula (7), as described Japanese Patent Publication Tokuhyo Hei-8-511812. A polyimide of the following formula (7) is a preferable form of a homopolymer of the formula (5).

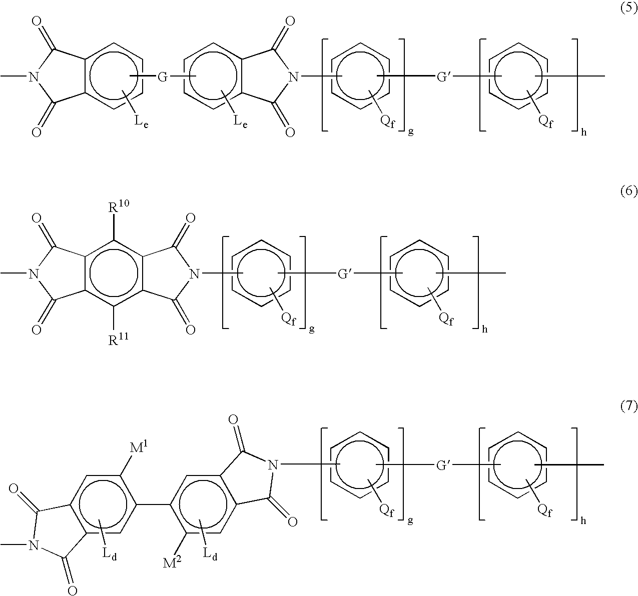

In the formulae (5) to (7), G and G′ each represent, for example, a covalent bond or a group independently selected from the group consisting of a CH₂ group, a C(CH₃)₂ group, a C(CF₃)₂ group, a C(CX₃)₂ group (herein, X represent halogen), a CO group, an O atom, an S atom, an SO₂ group, an Si(CH₂CH₃)₂ group, and an N(CH₃) group. They may be the same or different.

In the formulae (5) and (7), L represents a substituent, and d and e each represent the number of the corresponding substituent. L represents for example halogen, a C₁₋₃ alkyl group, a halogenated C₁₋₃ alkyl group, a phenyl group, or a substituted phenyl group, and when there are plural Ls, they may be the same or different. Examples of the substituted phenyl group include a substituted phenyl group having at least one substituent selected from the group consisting of halogen, a C₁₋₃ alkyl group, and a halogenated C₁₋₃ alkyl group. Examples of the halogen include fluorine, chlorine, bromine and iodine. d represents an integer from 0 to 2, and e represents an integer from 0 to 3.

In the above formulae (5) to (7), Q represents a substituent and f represents the number of substitutions thereof. An example of Q includes an atom or group selected from the group consisting of hydrogen, halogen, an alkyl group, a substituted alkyl group, a nitro group, a cyano group, a thioalkyl group, an alkoxy group, an aryl group, a substituted aryl group, an alkyl ester group, and a substituted alkyl ester group. When there are plural Qs, they may be the same or different. Examples of the halogen include fluorine, chlorine, bromine and iodine. An example of the substituted alkyl group includes a halogenated alkyl group.

An example of the substituted aryl group includes a halogenated aryl group. In the formulae, f represents an integer from 0 to 4, and g and h respectively represent an integer from 0 to 3 and an integer from 1 to 3, in which g and h each are preferably greater than 1.

In the formula (6), R¹⁰ and R¹¹ each represent a group independently selected from the group consisting of hydrogen, halogen, a phenyl group, a substituted phenyl group, an alkyl group and a substituted alkyl group.

Of them, R¹⁰ and R¹¹ each are preferably a halogenated alkyl group independently selected therefrom.

In the formula (7), M¹ and M² may be the same or different, and examples of them include halogen, a C₁₋₃ alkyl group, a C₁₋₃ halogenated alkyl group, a phenyl group or a substituted phenyl group.

Examples of the halogen include fluorine, chlorine, bromine and iodine.

An example of the substituted phenyl group includes a substituted phenyl group having at least one substituent selected from the group consisting of halogen, a C₁₋₃ alkyl group, and a C₁₋₃ halogenated alkyl group.

An example of polyimide represented in the formula (5) includes the one represented by the following formula (8).

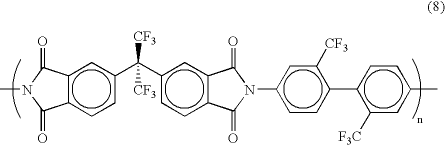

An example of the polyimide includes a copolymer prepared by appropriate copolymerization of dianhydride or diamine other than the aforesaid chemical architecture (repeat unit).

An example of the dianhydride includes aromatic tetracarboxilic dianhydride.

Examples of the aromatic tetracarboxilic dianhydride include pyromellitic dianhydride, benzophenon tetracarboxylic dianhyclrade, naphthalene tetracarboxylic dianhydride, heterocyclic aromatic tetracarboxylic dianhydride, and 2,2′-substituted biphenyl tetracarboxylic dianhydride.

Examples of the pyromellitic dianhydride include non-substituted pyromellitic dianhydride, 3,6-diphenyl pyromellitic dianhydride, 3,6-bis(trifluoromethyl)pyromellitic dianhydride, 3,6-dibromopyromellitic dianhydride, and 3,6-dichloropyromellitic dianhydride. Examples of the benzophenone tetracarboxylic dianhydride include 3,3′,4,4′-benzophenone tetracarboxylic dianhydride, 2,3,3′,4′-benzophenone tetracarboxylic dianhydride and 2,2′,3,3′-benzophenone tetracarboxylic dianhydride. Examples of the naphthalene tetracarboxylic dianhydride include 2,3,6,7-naphthalene-tetracarboxylic dianhydride, 1,2,5,6-naphthalene-tetracarboxylic dianhydride, and 2,6-dichloro-naphthalene-1,4,5,8-tetracarboxylic dianhydride. Examples of the heterocyclic aromatic tetracarboxylic dianhydride include thiophene-2,3,4,5-tetracarboxylic dianhydride, pyrazine-2,3,5,6-tetracarboxylic dianhyclride and pyridine-2,3,5,6-tetracarboxylic dianhydride.

Examples of the 2,2′-substituted biphenyl tetracarboxylic dianhydride include 2,2′-dibromo-4,4′,5,5′-biphenyl tetracarboxylic dianhydride, 2,2′-dichloro-4,4′,5,5′-biphenyl tetracarboxylic dianhydride and 2,2′-bis(trifluoromethyl)-4,4′,5,5′biphenyl tetracarboxylic dianhydride.

Other examples of the aromatic tetracarboxylic clianhydride may include 3,3′,4,4′-biphenyl tetracarboxylic dianhydride, bis(2,3-clicarboxyphenyl)methane dianhydride, bis(2,5,6-trifluoro-3,4-dicarboxyphenyl)methane dianhydride, 2,2-bis(3,4 dicarboxyphenyl)-1,1,1,3,3,3-hexafluoropropane dianhydride, 4,4′-(3,4-dicarboxyphenyl)-2,2-diphenylpropane dianhydride, bis(3,4-dicarboxyphenyl)ether dianhydride, 4,4′-oxydiphthalic dianhydride, bis(3,4-dicarboxyphenyl)sulfonic dianhydride (3,3′,4,4′diphenylsulfone tetracarboxylic dianhydride), 4,4′-[4,4′-isopropylidene-di(p-phenyleneoxy)]bis(phthalic dianhydride), N,N-(3,4-dicarboxyphenyl)-N-methylamine dianhydride and bis(3,4-dicarboxyphenyl)diethylsilane dianhydride.

Among the above, the aromatic tetracarboxylic dianhydride preferably is 2,2′-substituted biphenyl tetracarboxylic dianhydride, more preferably is 2,2′-bis(trihalomethyl)-4,4′,5,5′-biphenyl tetracarboxylic dianhydride, and further preferably is 2,2′-bis(trifluoromethyl)-4,4′,5,5′-biphenyl tetracarboxylic dianhydride.

The aforesaid diamine may be, for example, aromatic diamine. Specific examples thereof include benzenediamine, diaminobenzophenone, naphthalenediamine, heterocyclic aromatic diamine and other aromatic diamines.

The benzenediamine may be, for example, diamine selected from the group consisting of benzenediamines such as o-, m- or p-phenylenediamine, 2,4-diaminotoluene, 1,4-diamino-2-methoxybenzene, 1,4-diamino-2-phenylbenzene and 1,3-diamino-4-chlorobenzene. Examples of the diaminobenzophenone include 2,2′-diaminobenzophenone and 3,3′-diaminobenzophenone. The naphthalenediamine may be, for example, 1,8-diaminonaphthalene or 1,5-diaminonaphthalene. Examples of the heterocyclic aromatic diamine include 2,6-diaminopyridine, 2,4-diaminopyridine and 2,4-diamino-S-triazine.

Further, other than the above, the aromatic diamine may be 4,4′-diaminobiphenyl, 4,4′-diaminodiphenyl methane, 4,4′-(9-fluorenylidene)-dianiline, 2,2′-bis(trifluoromethyl)-4,4′-diaminobiphenyl, 3,3′-dichloro-4,4′-diaminodiphenyl methane, 2,2′-dichloro-4,4′-diaminobiphenyl, 2,2′,5,5′-tetrachlorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′-diamino diphenyl ether, 3,4′-diamino diphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis [4-(4-aminophenoxy)phenyl]propane, 2,2-bis [4-(4-aminophenoxy)phenyl]-1,1,1,3,3,3,-hexafluoropropane, 4,4′-diamino diphenyl thioether or 4,4′-diaminodiphenylsulfone.

The polyetherketone as the aforesaid resin material may be, for example, polyaryletherketone represented by the following formula (9), which is disclosed in Japanese Patent Application Laid-open No. 2001-49110.

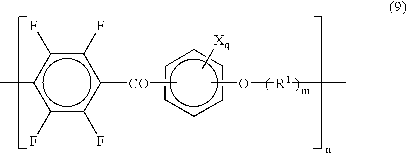

In the above formula (9), X represents a substituent, and q represents the number of the substitutions. X is, for example, a halogen atom, a lower alkyl group, a halogenated alkyl group, a lower alkoxy group or a halogenated alkoxy group, and when there are plural Xs, they may be the same or different.

The halogen atom may be, for example, a fluorine atom, a bromine atom, a chlorine atom or an iodine atom, and among these, a fluorine atom is preferable. The lower alkyl group preferably is a C₁₋₆ lower straight alkyl group or a C₁₋₆ lower branched alkyl group and more preferably is, for example, a C₁₋₄ straight or branched chain alkyl group. More specifically, it is preferably a methyl group, an ethyl group, a propyl group, an isopropyl group, a butyl group, an isobutyl group, a sec-butyl group or a tert-butyl group, and particularly preferably a methyl group or an ethyl group. The halogenated alkyl group may be, for example, a halide of the aforesaid lower alkyl group such as a trifluoromethyl group. The lower alkoxy group is preferably a C₁₋₆ straight or branched chain alkoxy group and more preferably is, for example, a C₁₋₄ straight or branched chain alkoxy group. More specifically, it is further preferably a methoxy group, an ethoxy group, a propoxy group, an isopropoxy group, a butoxy group, an isobutoxy group, a sec-butoxy group or a tert-butoxy group, and particularly preferably a methoxy group or an ethoxy group. The halogenated alkoxy group may be, for example, a halide of the aforesaid lower alkoxy group such as a trifluoromethoxy group.

In the above formula (9), q is an integer from 0 to 4. In the formula (9), it is preferable that q=0 and a carbonyl group and an oxygen atom of an ether that are bonded to both ends of a benzene ring are present at para positions.

Also, in the above formula (9), R¹ is a group represented by the following formula (10), and m is an integer of 0 or 1.

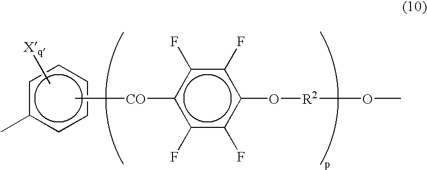

In the above formula (10), X′ is a substituent and is, for example, the same as X in the formula (9). In the formula (10), when there are plural X's, they may be the same or different. q′ represents the number of substitutions of the X′ and is an integer from 0 to 4, preferably, q′=0. In addition, p is an integer of 0 or 1.

In the formula (10), R² represents a divalent aromatic group. This divalent aromatic group may be, for example, an o-, m- or p-phenylene group or a divalent group derived from naphthalene, biphenyl, anthracene, o-, m- or p-terphenyl, phenanthrene, dibenzofuran, biphenyl ether or biphenyl sulfone. In these (livalent aromatic groups, hydrogen that is bonded directly to the aromatic may be substituted with a halogen atom, a lower alkyl group or a lower alkoxy group. Of them, the R² preferably is an aromatic group selected from the group consisting of the following formulae (11) to (17).

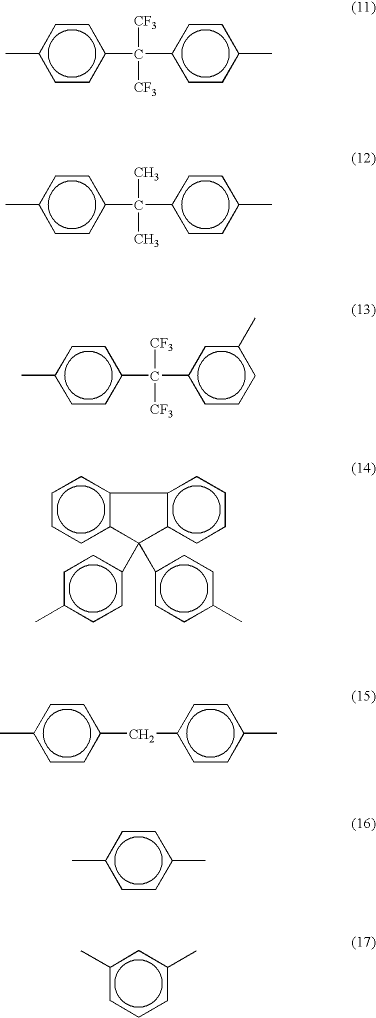

In the above formula (9), the R¹ is preferably a group represented by the following formula (18), in which R² and p are equivalent to those in the aforesaid formula (10).

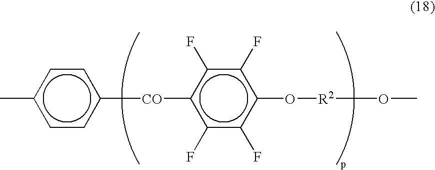

Furthermore, in the formula (9), n represents a degree of polymerization ranging for example, from 2 to 5,000 and preferably from 5 to 500. The polymerization may be composed of repeating units having the same structure or different structures. In the latter case, the polymerization form of the repeating units may be a block polymerization or a random polymerization.

Moreover, it is preferable that an end on a p-tetrafluorobenzoylene group side of the polyaryletherketone represented by the formula (9) is fluorine and an end on an oxyalkylene group side thereof is a hydrogen atom. Such a polyaryletherketone can be represented by the following general formula (19). In the following formula, n represents a degree of polymerization as in the formula (9).

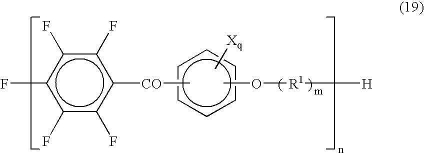

Specific examples of the polyaryletherketone represented by the formula (9) may include those represented by the following formulae (20) to (23), in which n represents a degree of polymerization as in the formula (9).

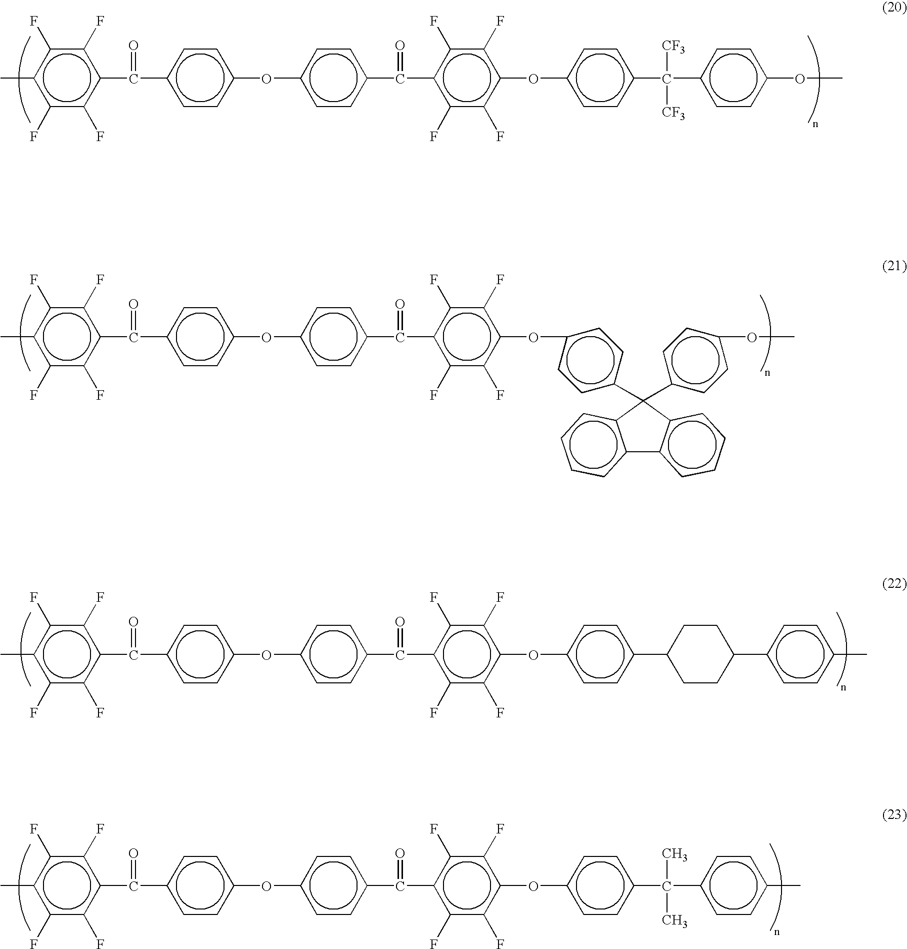

Other than the above, the polyamide or polyester as the aforesaid resin material may be, for example, polyamide or polyester described by Japanese Patent Publication Tokuhyo Hei-10-508048, and their repeating units can be represented by the following general formula (24).

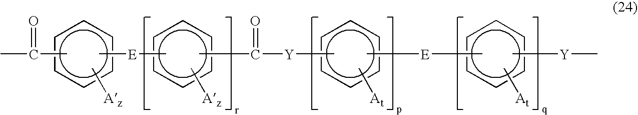

In the above formula (24), Y is O or NH. E is, for example, a covalent bond or at least one group selected from the group consisting of a C₂ alkylene group, a halogenated C₂ alkylene group, a CH₂ group, a C(CX₃)₂ group (herein X is halogen or hydrogen), a CO group, an O atom, an S atom, an SO₂ group, an Si(R)₂ group and an N(R) group, and Es may be the same or different. In the aforesaid E, R is at least one of a C₁₋₃ alkyl group and a halogenated C₁₋₃ alkyl group and presents at a meta position or a para position with respect to a carbonyl functional group or the Y group.

Further, in the above formula (24), A and A′ are substituents, and t and z respectively represent the numbers of the substitutions. Additionally, p is an integer from 0 to 3, q is an integer from 1 to 3, and r is an integer from 0 to 3.

The aforesaid A is selected from the group consisting of, for example, hydrogen, halogen, a C₁₋₃ alkyl group, a C₁₋₃ halogenated alkyl group, an alkoxy group represented by OR (wherein R is the group defined above), an aryl group, a substituted aryl group by halogenation or the like, a C₁₋₉ alkoxycarbonyl group, a C₁₋₉ alkylcarbonyloxy group, a C₁₋₁₂ aryloxycarbonyl group, a C₁₋₁₂ arylcarbonyloxy group and a substituted derivative thereof, a C₁₋₁₂ arylcarbamoyl group, and a C₁₋₁₂ arylcarbonylamino group and a substituted derivative thereof. When there are plural As, they may be the same or different. The aforesaid A′ is selected from the group consisting of, for example, halogen, a C₁₋₃ alkyl group, a halogenated C₁₋₃ alkyl group, a phenyl group and a substituted phenyl group and when there are plural A's, they may be the same or different. A substituent on a phenyl ring of the substituted phenyl group can be, for example, halogen, a C₁₋₃ alkyl group, a C₁₋₃ halogenated alkyl group or a combination thereof. The t is an integer from 0 to 4, and the z is an integer from 0 to 3.

Among the repeating units of the polyamide or polyester represented by the formula (24), the repeating unit represented by the following general formula (25) is preferable.

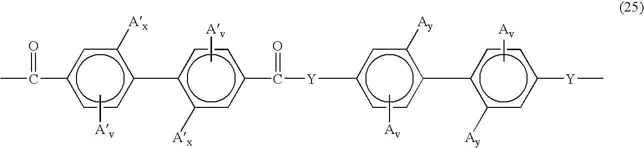

In the formula (25), A, A′ and Y are those defined by the formula (24), and v is an integer from 0 to 3, preferably is an integer from 0 to 2. Although each of x and y is 0 or 1, not both of them are 0.

The polyester may be the one having a repeating unit represented by the following general formulae (26) and (27).

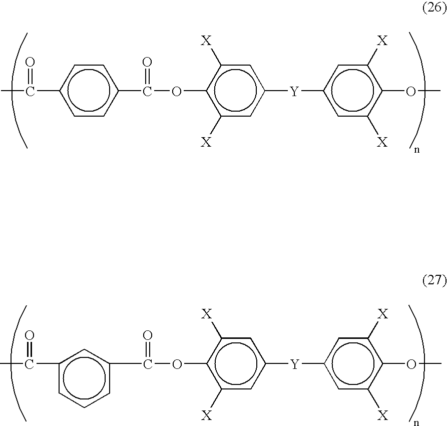

In the formulae (26) and (27), X and Y each represent a substituent. The X is selected from the group consisting of hydrogen, chlorine and bromine. The Y is selected from the group consisting of the following formulae (28), (29), (30) and (31).

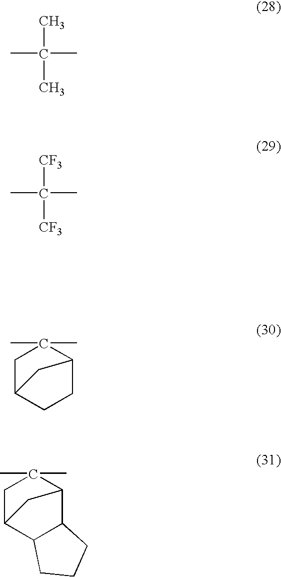

The polyester may be a copolymer combined with polyester represented in the general formulae (26), (27).

The solvent for dissolving the resin material is not particularly limited as long as it can dissolve the resin material and does not excessively eat into the substrate film, and can be selected suitably according to the resin material and the substrate film to be used. Examples thereof include halogenated hydrocarbons, such as chloroform, dichloromethane, carbon tetrachloride, dichloroethane, tetrachloroethane, trichloroethylene, tetrachloroethylene, chlorobenzene and o-dichlorobenzene; phenols, such as phenol and parachlorophenol; aromatic hydrocarbons, such as benzene, toluene, xylene, methoxybenzene and 1,2-dimethoxybenzene; acetone; ethyl acetate; t-butyl alcohol; glycerin; ethylene glycol; triethylene glycol; ethylene glycol monomethyl ether; diethylene glycol dimethyl ether; propylene glycol; dipropylene glycol; 2-methyl-2,4-pentanediol; ethyl cellosolve; butyl cellosolve; 2-pyrrolidone; N-methyl-2-pyrrolidone; pyridine; triethylamine; dimethylformamide; dimethylacetoamide; acetonitrile; butyronitrile; methyl isobutyl ketone; methylethylketone; cyclopentanone; and carbon disulfide.

Among the aforesaid solvents, methylisobutylketone is particularly preferable because it has an excellent solubility for a resin composition and does not eat into a substrate film.

These solvents may be used alone or in combination of two or more according to needs and circumstances.

Additives may be appropriately added in the resin solution according to needs and circumstances. Although no particular limitation is intended, as additives, it is possible to use a UV absorber, a deterioration preventing agent (e.g., an antioxidant, a peroxide decomposing agent, a radical inhibitor, a metal deactivator, an acid capturing agent and an amine), a plasticizer and an antistatic agent, as well as additives for achieving an optional purpose, such as securing adhesiveness relative to a plastic substrate as a support medium. The number of additives to be blended are preferably within a range not deteriorating the characteristics of a retardation plate.

The resin solution application method is not limited to a specific one, and can be cited as examples a spin coating method, a roll coating method, a flow coating method, a print coating method, a dip coating method, a cast coating method, a bar coating method and a gravure printing method. A resin solution may be directly applied onto a substrate film, or may be applied thereto via one or two or more layers.

The coating layer immobilizing method is not necessarily limited to a specific one, and may be appropriately determined according to the type of a polymeric resin, the number of blended components, the material of a substrate film, or the like.

A drying method can be cited as an example of the immobilizing method, and more specifically natural drying or heat drying (e.g., heating at 40° C. to 350° C.) can be cited. This drying step may be carried out at two stages under different conditions.

In a case where a resin having a photopolymerizable functional group, which is cured with light rays such as ultraviolet rays, a coating layer can be immobilized by irradiating visible light or ultraviolet light after volatilizing a solvent to some extent by carrying out a heat treatment.

The thickness of the immobilized coating layer is usually from 0.2 to 50 μm and preferably from 1 to 30 μm. When the thickness is from 1 to 30 μm, coating unevenness or drying unevenness may be prevented so that appearance defect can be further reduced.

A polarizing plate of the present invention is made up of a laminate of the thus prepared optical functional film and a polarizer, without limitation to other components. A retardation film may be directly laminated with a polarizer and may be laminated together via a different material.

The polarizer is not necessarily limited to a specific one, and any one prepared by a known method, which involves, for example, allowing various types of films each to absorb a dichromatic substance, such as iodine or a dichromatic dye, thereby dying the film, and stretching, crosslinking and drying the film. Of them, it is preferable to use a film that can transmit linearly polarized light when natural light is made incident thereon and that has excellent light transmittance and polarizing degree. Examples of the variety of films in which the dichroic substance is to be adsorbed include hydrophilic polymer films, such as polyvinyl alcohol (PVA)-based films, partially-formalized PVA-based films, partially-saponified films based on ethylene-vinyl acetate copolymer and cellulose-based films. In addition to these films, polyene oriented films, such as dehydrated PVA and dehydrochlorinated polyvinyl chloride, can be used. Of them, the PVA-based film is preferable. In addition, the thickness of the polarizer generally ranges from 1 to 80 μm although it is not limited to such a thickness.

As a specific example of the polarizing plate of the present invention, it can be cited a polarizing plate made up of a laminate of the thus prepared optical functional film of the present invention (e.g., retardation film), a polarizer and a transparent protection film.

The transparent protection film may be subjected on at least one of the opposite surfaces thereof to surface treatment for the purpose of hard coat treatment, antireflection treatment, treatments for anti-sticking, diffusion and anti-glaring, or the like. The hard coat treatment is intended to prevent scratching on a surface of a polarizing plate, which involves, for example, forming a cured coating layer on a surface of the transparent protection film, which layer is made of a curable resin and excellent in hardness, lubricity and the like. Examples of the curable resin that can be used include UV-curable resin, such as silicone resin, urethane resin, acrylic resin and epoxy resin. The treatment may be carried out following a conventional technique. The treatment for anti-sticking is intended to prevent adhesion to an adjacent layer. The antireflection treatment is intended to prevent reflection of outside light on the surface of the polarizing plate, which can be achieved by forming a conventional antireflection layer or the like. The treatment for anti-glaring is intended to prevent the visibility of light transmitted by the polarizing plate from being inhibited by the reflection of outside light by the surface of the polarizing plate, which treatment can be achieved by, for example, forming a fine roughness surface structure on the surface of the transparent protection film, following a conventional technique.

The method of laminating the retardation film with the polarizing plate (or polarizer) is not necessarily limited to a specific one and any conventional method may be employed. In general, it is possible to use any sticking agent or adhesive, and the type of each of them may be appropriately determined according to the material of the retardation film or the like. Examples of the adhesive include polymer pressure sensitive adhesives, such as acrylic, vinyl alcohol-based, silicone-based, polyester-based, polyurethane-based and polyether-based adhesives, and rubber-based pressure-sensitive adhesives. It is also possible to use an adhesive made of, for example, an aqueous crosslinking agent of a vinyl alcohol-based polymer, such as glutaric aldehyde, melamine or oxalic acid. As these adhesives or sticking agents, it is preferable to use, for example, those that are unlikely to be peeled even if they are influenced by temperature and heat, and are excellent in light transmittance and polarizing degree. Specifically, when the polarizer is a PVA-based film, a PVA-based adhesive is preferable in light of stability of adhering treatment and the like. These adhesive and sticking agent may be applied onto a surface of the polarizer, the transparent protection film or the like, or a layer of a tape or a sheet formed of the adhesive or sticking agent may be arranged on the surface thereof.

An image display device of the present invention has the optical functional film disposed on a display screen thereof. As the image display device, it is possible to employ an appropriate image display device, such as a transmissive or reflective liquid-crystal device, and an organic electroluminescence device.

The liquid crystal display device is not necessarily limited to a specific one, and it is possible to use a liquid crystal display device that uses, for example, a twisted nematic (TN) mode liquid crystal cell, a vertical aligned (VA) mode liquid crystal cell, or an in-plane switching (IPS) mode liquid crystal cell. Of them, a vertical aligned (VA) mode liquid crystal cell is a good match with the optical functional film and can form a liquid crystal display device with excellent image display characteristics.

Specifically, a vertical aligned (VA) mode liquid crystal cell employs nematic liquid crystal having negative dielectric anisotropy, as liquid crystal molecules forming a liquid crystal layer, and these liquid crystal molecules are aligned vertically on a surface of a substrate when no voltage is applied. Under no voltage applied condition, linearly polarized light which has passed a first polarizing plate is entered through one of the substrate surfaces into a liquid crystal layer so that the incident light advances along a longitudinal direction of the vertically aligned liquid crystal molecules. No birefringence occurs in the longitudinal direction of the liquid crystal molecules, and thus the incident light advances without changing a polarization direction and is absorbed by a second polarizing plate having a polarizing axis perpendicular to the first polarizing plate. Whereby, dark display is provided when no voltage is applied. When voltage is applied between the substrates, the liquid crystal molecules have the longitudinal axis being aligned in parallel to the substrate surface. Under such a voltage applied condition, the liquid crystal molecules exhibit birefringence characteristics to the light incident on the liquid crystal layer, and thereby the polarized state of the incident light is changed according to the inclination of the liquid crystal molecules. For example, in a case where the polarization state turns to be a linear polarization state with the polarization direction of light passing through the liquid crystal layer rotated 90 degrees when a given maximum voltage is applied, the incident light passes the second polarizing plate as well so that the display device is capable of providing light display.

The thus structured VA mode liquid crystal display device has excellent image display characteristics because of its high contrast, while having optical characteristics (nx=ny<nz), in which the out-of-plane refractive index is larger than the in-plane refractive index, thus posing a problem of causing a viewing angle dependence of a display. In order to reduce the viewing angle dependence by optical compensation, an optical compensation layer having optical characteristics (nx=ny>nz), in which the refractive index is smaller in the out-of-plane direction, is required.

On the other hand, the optical functional film of the present invention is especially suitable for a case in which an optical compensation layer having optical characteristics (nx=ny>nz), in which the refractive index is smaller in the out-of-plane direction, is provided.

Specifically, it is possible to obtain an optical functional film containing an optical functional layer having optical characteristics (nx=ny>nz), in which the refractive index is smaller in the out-of-plane direction, by carrying out a stretching step of stretching a substrate film with the substrate film kept heated, an application step of applying a resin solution containing polyimide on the substrate film, as described above, and an immobilizing step of immobilizing the applied polyimide to form a polyimide layer. That is, it is possible to obtain an optical functional film that has optical characteristics (nx=ny>nz), in which the refractive index is smaller in the out-of-plane direction, and has excellent appearance characteristics without streaky coating unevenness, by only immobilizing the polyimide layer on the substrate film without carrying out the stretching step in the following processing.

The thus structured optical functional film realizes an optically isotropic property of a liquid crystal display device by the combination with the VA mode liquid crystal cell, and enables providing an image display device having excellent viewing angle characteristics and appearance characteristics.

By stretching an optical functional layer having the aforesaid optical characteristics of nx=ny>nz in one in-plane direction, the optical functional layer can have biaxial optical characteristics of nx>ny>nz. An optical compensation layer having the biaxial optical characteristics of nx>ny>ny is suitable for preventing light leakage due to the displacement of the axis of a polarizer when the polarizer set in a cross-Nicol position is viewed from an oblique direction.

### EXAMPLES

Now, the detailed description will be made for the present invention with reference to Examples, with no intention to limit the present invention to the following Examples. The measuring methods employed in Examples will be described below.

<Method of Measuring the Surface Roughness of a Substrate Film>

A specimen 30 mm by 30 mm square was taken from a widthwise center portion of a substrate film. The surface roughness (μm) of the specimen in the widthwise direction of the substrate film (TD direction) for the specimen by a high-precision micro-contour measuring instrument (ET4000 made by Kosaka Laboratory Ltd.) and its average value was designated as a surface roughness (μm).

The measuring conditions of the high-precision micro-contour measuring instrument were set as follows.

Scanning rate: 0.5 mm/sec

Evaluation interval: 3 μm

X-axis scale resolution: 0.01 μm

Z-direction resolution: 0.1 nm (±3.2 μm range)

Radius of a sensing pin leading end: 0.5 μm(Diamond)

<Method of Measuring the Average Declination Angle of the Surface Roughness of a Substrate Film>

A specimen 30 mm by 30 mm square was taken from a portion of a substrate film, which portion being located 30 mm inwardly away from an edge of the substrate film in the widthwise direction (TD direction), and a specimen 30 mm by 30 mm square was taken from a widthwise center portion of the substrate film. The declination angle of the surface roughness in the substrate film widthwise direction (TD direction) was measured at two points for each of the specimens by a high-precision micro-contour measuring instrument (same as the above), and the average value of the measured declination angle measured at four points in total was designated as the average declination angle (°).

The measuring conditions of the measuring instrument were the same as those of the surface roughness measuring.

<Method of Measuring the Thickness of a Resin Layer>

An optical functional film specimen 30 mm by 30 mm square was taken from a widthwise center portion of a substrate film after a resin solution was applied thereon, and the thickness of a resin layer was measured by a spectrophotometer (USB2000 made by Ocean Optics, Inc.) using a peak-valley method.

<Method of Measuring a Glass-Transition Temperature Tg>

Measurement was made by a TMA method.

<Criteria for the Visual Judgment>

◯ No streaky coating unevenness visually observable was confirmed so that an even appearance was obtained.

Δ Even though small, moderate streaky coating unevenness was confirmed, an appearance having no practical problems was obtained.

× Noticeable strong unevenness was confirmed at some portions.

### Example 1

An elongated triacetylcellulose film (TF-80UL made by Fuji Photo Film Co., Ltd., Film thickness: 80 μm, Width: 1330 mm, Tg: 145° C.) was used as a substrate film, which was heated to 145° C. and the opposite lateral edges thereof were respectively gripped by a pair of gripping members provided in a stretching machine. The pair of gripping members were moved in the lengthwise direction of the substrate film and gradually moved away from each other so as to increase the distance therebetween to 1.1 times (maximum stretching ratio). Thus, the substrate film was stretched. Then, the substrate film was relaxed until the distance of the pair of gripping members reaches 1.09 times (final stretching ratio) (i.e., the relaxation rate of 0.992 times).

On the other hand, a polyimide solution having a polyimide concentration of 10% by weight and a viscosity of 200 mPa s was prepared by dissolving polyimide (the following formula (32), weight-average molecular weight (Mw)=140,000) in methyl isobutyl ketone.

Then, the polyimide solution was applied onto the substrate film obtained in a manner mentioned above using a die coater as an applicator, dried for 3 minutes at 120° C. Thus, a resin layer having a thickness of 3.0 μm was formed.

The appearance of the thus obtained optical functional film was checked with eyes and no streaky coating unevenness (striped pattern) in the lengthwise direction was found. The results of the other measurements are shown in Table 1.

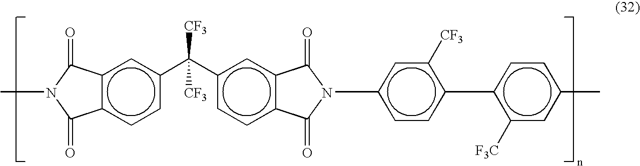

### Example 2

An optical functional film was prepared in the same manner as in Example 1, except that an elongated triacetylcellulose film (TFY-80UL made by Fuji Photo Film Co., Ltd., Film thickness: 80 μm, Width: 1330 mm) was used as a substrate film.

The appearance of the thus obtained optical functional film was checked with eyes and no streaky coating unevenness was found. The results of the other measurements are shown in Table 1.

### Example 3

An optical functional film was prepared in the same manner as in Example 1, except that an elongated triacetylcellulose film (TFY-80UL made by Fuji Photo Film Co., Ltd., Film thickness: 80 μm, Width: 1475 mm) was used as a substrate film.

The appearance of the thus obtained optical functional film was checked with eyes and no streaky coating unevenness was found. The results of the other measurements are shown in Table 1.

### Comparative Examples 1 to 3

An optical functional film was prepared by using the same triacetylcellulose film as that of Examples 1 to 3 as a substrate film, applying a polyimide solution thereon in the same manner, but without stretching the substrate film, and drying the same.

The appearance of the thus obtained optical functional film of each of Comparative Examples 1 to 3 was checked with eyes and occurrence of streaky coating unevenness (striped pattern) in the lengthwise direction of the substrate film was confirmed. The results of the other measurements are shown in Table 1.

### Example 4

An optical functional film was prepared in the same manner as in Example 1, except that an elongated triacetylcellulose film (TD-80UL made by Fuji Photo Film Co., Ltd., Film thickness: 80 μm, Width: 1330 mm, Tg: 145° C.) was used as a substrate film, and there were employed the heating temperature in the stretching step: 163° C., the maximum stretching ratio in the stretching step: 1.05 times, the relaxation rate: 0.998 times and the final stretching ratio: 1.05 times. The results of the measurements are shown in Table 1.

### Example 5

An optical functional film was prepared in the same manner as in Example 4, except that there were employed the maximum stretching ratio in the stretching step: 1.08 times, the relaxation rate: 0.998 times and the final stretching ratio: 1.08 times. The results of the measurements are shown in Table 1.

### Example 6

An optical functional film was prepared in the same manner as in Example 4, except that there were employed the maximum stretching ratio in the stretching step: 1.1 times, the relaxation rate: 0.998 times and the final stretching ratio: 1.1 times. The results of the measurements are shown in Table 1.

### Comparative Example 4

An optical functional film was prepared in the same manner as in Example 4, except that the stretching step was not carried out. The results of the measurements are shown in Table 1.

### Comparative Example 5

An optical functional film was prepared in the same manner as in Example 4, except that the stretching step was not carried out, and the substrate film was subjected only to an annealing treatment, in which it was heated to 163° C. The results of the measurements are shown in Table 1.

### Example 7

An optical functional film was prepared in the same manner as in Example 1, except that an elongated olefin-based film (ZEONOR made by ZEON Corporation, Film thickness: 80 μm, Width: 1330 mm, Tg: 137° C.) was used as a substrate film, and there were employed the heating temperature in the stretching step: 155° C., the maximum stretching ratio in the stretching step: 2.5 times, the relaxation rate: 0.995 times and the final stretching ratio: 2.49 times. The results of the measurements are shown in Table 1.

### Example 8

An optical functional film was prepared in the same manner as in Example 7, except that there were employed the maximum stretching ratio in the stretching step: 3.5 times, the relaxation rate: 0.998 times and the final stretching ratio: 3.49 times. The results of the measurements are shown in Table 1.

### Comparative Example 6

An optical functional film was prepared in the same manner as in Example 7, except that the stretching step was not carried out. The results of the measurements are shown in Table 1.

TABLE 1
TEST CONDITIONS ANDRESUTS OF EXAMPLES AND COMPARATIVE EXAMPLES

| | | | | | | | | | | Standard | |
|---|---|---|---|---|---|---|---|---|---|---|---|
| | | | | | | | | | | Deviation | |
| | | | | | | | | | | of the | |
| | | | | | | | | | | Thickness | |
| | Substrate Film | | | Stretching | Maximum | | Final | Surface | Average | of a Resin | |
| | | Width | | Temperature | Stretching | Relaxation | Stretching | Roughness | Declination | Layer | Visual |
| | Type | (mm) | Tg (° C.) | (° C.) | Ratio | Rate | Ratio | (μm) | Angle (°) | (nm) | Evaluation |
| Example 1 | TF-80UL | 1330 | 145 | 145 | 1.1 | 0.992 | 1.091 | 0.03 | 0.004 | 8.1 | ◯ |
| Example 2 | TFY-80UL | 1330 | 145 | 145 | 1.1 | 0.992 | 1.091 | 0.04 | 0.005 | 8.4 | ◯ |
| Example 3 | TFY-80UL | 1475 | 145 | 145 | 1.1 | 0.992 | 1.091 | 0.04 | 0.004 | 8.2 | ◯ |
| Comparative | TF-80UL | 1330 | 145 | — | — | — | — | 0.09 | 0.012 | 22.2 | X |
| Example 1 | | | | | | | | | | | |
| Comparative | TFY-80UL | 1330 | 145 | — | — | — | — | 0.12 | 0.015 | 23.0 | X |
| Example 2 | | | | | | | | | | | |
| Comparative | TFY-80UL | 1475 | 145 | — | — | — | — | 0.12 | 0.014 | 22.6 | X |
| Example 3 | | | | | | | | | | | |
| Example 4 | TD-80UL | 1330 | 145 | 163 | 1.05 | 0.998 | 1.048 | 0.07 | 0.009 | 11.4 | Δ |
| Example 5 | TD-80UL | 1330 | 145 | 163 | 1.08 | 0.998 | 1.078 | 0.06 | 0.007 | 11.0 | Δ |
| Example 6 | TD-80UL | 1330 | 145 | 163 | 1.1 | 0.998 | 1.098 | 0.04 | 0.006 | 8.8 | ◯ |
| Comparative | TD-80UL | 1330 | 145 | — | — | — | — | 0.07 | 0.010 | 13.4 | X |
| Example 4 | | | | | | | | | | | |
| Comparative | TD-80UL | 1330 | 145 | 163 | — | — | — | 0.10 | 0.011 | 17.3 | X |
| Example 5 | | | | | | | | | | | |
| Example 7 | ZEONOR | 1330 | 137 | 155 | 2.5 | 0.995 | 2.488 | 0.003 | 0.004 | 3.2 | ◯ |
| Example 8 | ZEONOR | 1330 | 137 | 155 | 3.5 | 0.998 | 3.493 | 0.003 | 0.003 | 2.1 | ◯ |
| Comparative | ZEONOR | 1330 | 137 | — | — | | — | 0.010 | 0.010 | 15.7 | X |
| Example 6 | | | | | | | | | | | |

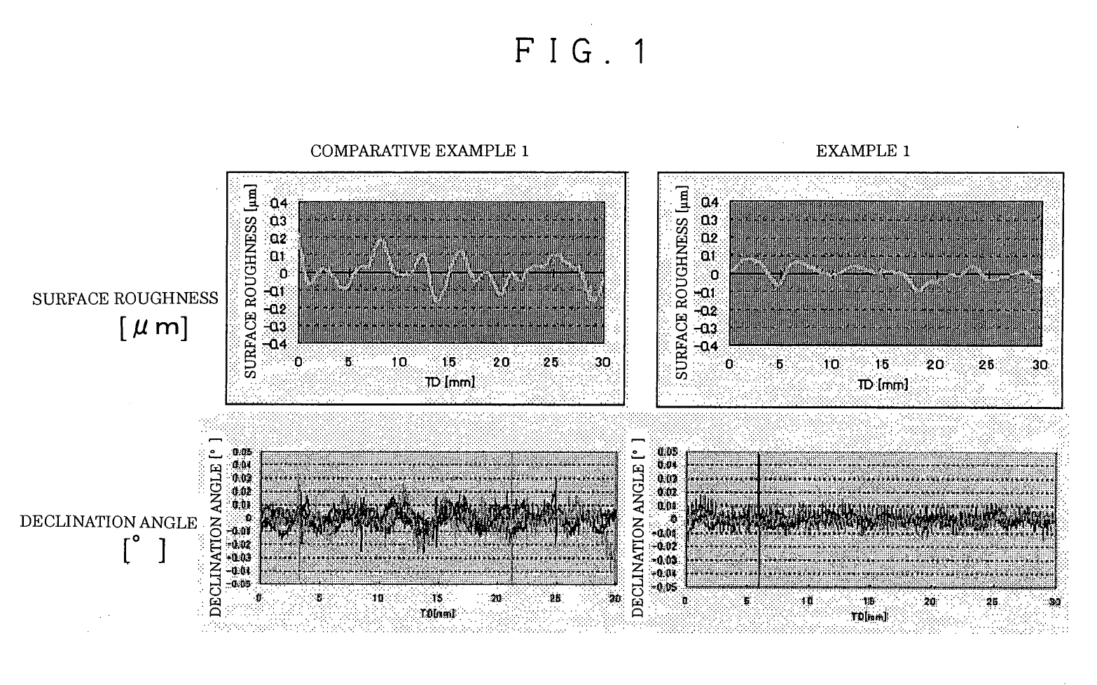

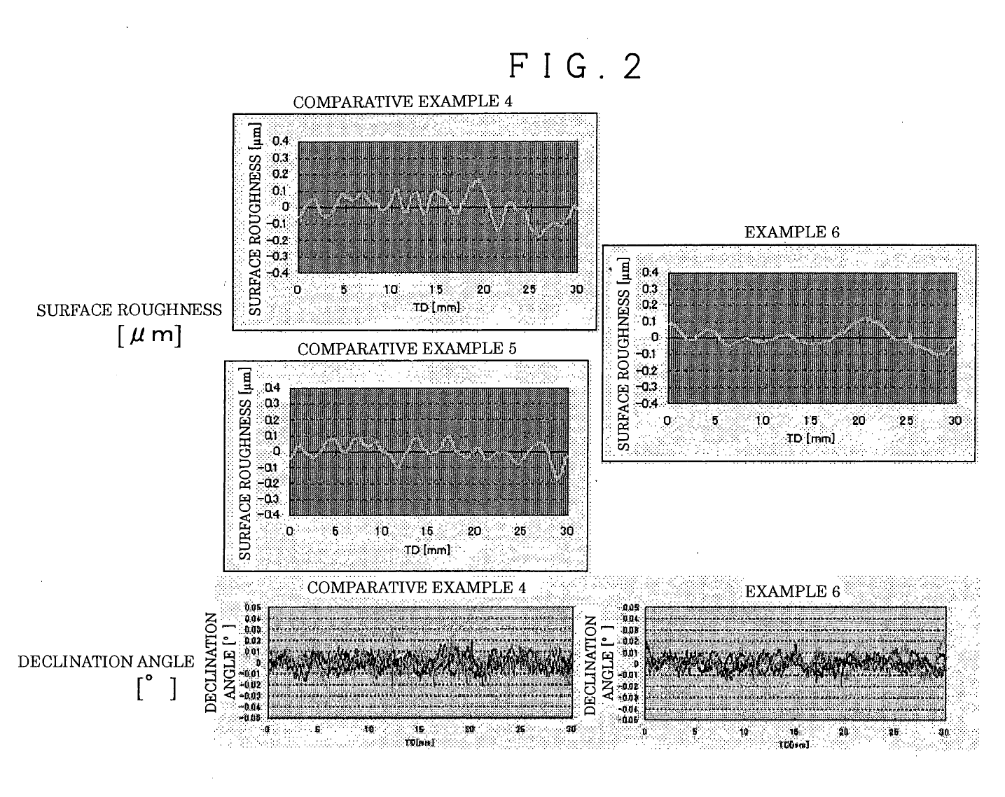

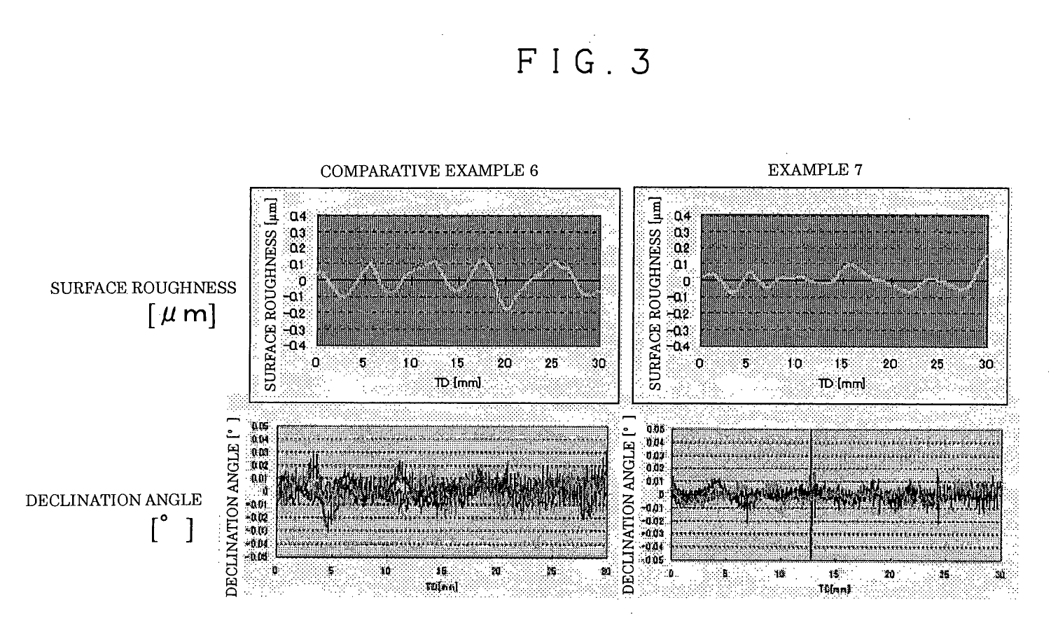

The measured data of the surface roughness and the declination angle for Example 1 and Comparative Example 1, the measured data of the surface roughness and the declination angle for Example 6 and Comparative Examples 4 and 5, and the measured data of the surface roughness and the declination angle for Example 7 and Comparative Example 6 are respectively illustrated in FIG. 1, FIG. 2 and FIG. 3.

As shown in TABLE 1, it is found that the optical functional films prepared by the methods including the stretching step each are given high marks on visual evaluation and more specifically have a good appearance, as compared with the optical functional films of the Comparative Examples prepared by the methods including no stretching step.

The results by the visual evaluation are in compliance with the results of the surface roughness (μm), the average declination angle (°) of the surface roughness and the standard deviation of the resin layer thickness, of the substrate film, and therefore supported also from these measured results.

The comparison of the measured values of the surface roughness and the declination angle obtained in Example 1 and Comparative Example is illustrated in FIG. 1. According to FIG. 1, it is more clearly shown that the fluctuation in surface roughness and declination angle, of the optical functional film of Example 1 is greatly reduced as compared with that of Comparative Example 1.

Likewise, the comparison of the measured values obtained in Example 6, and Comparative Examples 4 and 5 is illustrated in FIG. 2. According to FIG. 2, it is more clearly shown that the fluctuation in surface roughness and declination angle, of the optical functional film of Example 6 is greatly reduced, as compared with that of each of Comparative Examples 4 and 5.

Likewise, the comparison of the measured values obtained in Example 7 and Comparative Example 6 is illustrated in FIG. 3. According to FIG. 3, it is more clearly shown that the fluctuation in surface roughness and declination angle, of the optical functional film of Example 7 is greatly reduced, as compared with that of Comparative Example 6.

1. A method of manufacturing an optical functional film comprising an application step of applying a resin solution onto a substrate film made of a thermoplastic resin and an immobilizing step of immobilizing a resin applied to form a resin layer, wherein the method further comprises, prior to the application step, a stretching step of stretching the substrate film with the substrate film kept heated.

2. The method of manufacturing an optical functional film according to claim 1, wherein the temperature to which the substrate film is heated in the stretching step is from 80 to 300° C.

3. The method of manufacturing an optical functional film according to claim 1, wherein the temperature to which the substrate film is heated in the stretching step is from Tg−30° C. to Tg+60° C. when a glass-transition temperature of a resin that forms the substrate film is represented as Tg.

4. The method of manufacturing an optical functional film according to claim 1, wherein the stretching ratio of the substrate film in the stretching step is within a range of from 1.001 to 4.0 times.

5. The method of manufacturing an optical functional film according to claim 1, wherein the thermoplastic resin of the substrate film is any one selected from the group consisting of a polyester-based resin, a polycarbonate-based resin, a cellulose-based resin and a norbornene-based resin.

6. The method of manufacturing an optical functional film according to claim 1, wherein the resin solution contains at least one resin selected from the group consisting of polyamide, polyimide, polyester, polyetherketone, polyamide-imide and polyester-imide.

7. The method of manufacturing an optical functional film according to claim 1, wherein the thickness of the resin layer is not more than 30 gm.

8. An optical functional film manufactured by the method of claim 1.

9. The optical functional film according to claim 8, wherein the optical functional film has refractive index characteristics of nx≧ny>nz.

10. The optical functional film according to claim 8, wherein it is used in a VA mode liquid crystal display device.

11. A polarizing plate comprising a laminate of the optical functional film of claim 8 and a polarizer.

12. An optical element comprising a laminate including the optical functional film of claim 8.

13. An image display device comprising the optical functional film of claim 8.
